(19) United States
(12) Patent Application Publication
(10) Pub. No.: US 2016/0328733 A1
(43) Pub. Date: Nov. 10, 2016

(54) DISTRIBUTED SYSTEM FOR PRESENTING ACTIVITIES WITH CHANCE-BASED OUTCOMES BASED ON TRANSACTION DATA

(71) Applicant: Gilbarco Inc., Greensboro, NC (US)

(72) Inventor: Tal Reichert, Medford, MA (US)

(21) Appl. No.: 15/216,178

(22) Filed: Jul. 21, 2016

Related U.S. Application Data
(63) Continuation of application No. 13/938,468, filed on Jul. 10, 2013.
(60) Provisional application No. 61/670,287, filed on Jul. 11, 2012.

(51) Int. Cl. G06Q 30/02; G06Q 20/20

(52) U.S. Cl. CPC G06Q 30/0212; G06Q 20/202

(57) ABSTRACT

Disclosed are methods, systems, apparatus, devices, products and other implementations, including a method that includes receiving, at one or more processor-based devices, information about at least one transaction, including information about at least one first item selected by a customer in the at least one transaction, and determining, at the one or more processor-based devices, data relating to a reward provided to the customer in response to achieving a chance-based outcome for an activity performable by the customer, the data relating to the reward determined, at least in part, based on the received information.

### CROSS-REFERENCE TO RELATED APPLICATIONS

This application claims the benefit of, and priority to, provisional U.S. application Ser. No. 61/670,287, entitled “SYSTEMS AND METHODS FOR PRESENTING ACTIVITIES WITH CHANCE-BASED OUTCOMES,” filed Jul. 11, 2012 and is a Continuation of Ser. No. 13/938,468, entitled “SYSTEMS AND METHODS FOR PRESENTING ACTIVITIES WITH CHANCE-BASED OUTCOMES AND ASSOCIATED REWARDS,” filed on Jul. 10, 2013, the contents of both are incorporated herein by reference in their entirety.

### BACKGROUND

Commercial entities devote considerable resources to marketing and promotion of their businesses. To achieve their marketing objectives, the commercial entities try to implement marketing strategies that enable them to individually target customers in a manner that would entice the customers to participate in the commercial entities' marketing efforts.

### SUMMARY

In some variations, a method is disclosed that includes receiving, at one or more processor-based devices, information about at least one transaction, including information about at least one first item selected by a customer in the at least one transaction, and determining, at the one or more processor-based devices, data relating to a reward provided to the customer in response to achieving a chance-based outcome for an activity performable by the customer, the data relating to the reward determined, at least in part, based on the received information.

Embodiments of the method may include at least some of the features described in the present disclosure, including one or more of the following features.

The at least one transaction may include one or more of, for example, a purchase transaction, and/or a marketing review transaction.

The method may further include determining the activity with the chance-based outcome, and determining a probability value for the chance-based outcome of the activity based, at least in part, on the received information.

Determining the activity with the chance-based outcome may include determining the activity based on the received information.

The information about the at least one transaction may further include information about the customer.

The activity with the chance-based outcome may include one or more of, for example, participating in a chance-based lottery, and/or revealing concealed areas of a scratch card.

The method may further include presenting the activity performable by the customer on an interactive display device.

The method may further include presenting the activity performable by the customer on a printable medium.

The reward may include at least one second item offered at a discount.

Determining the data relating to the reward may include determining the reward to be presented to the customer based on the information about the at least one item selected by the customer and based on effective measures that are each associated with at least one combination from a set of combinations that each includes the at least one first item and a corresponding reward to be presented to the customer, each of the effectiveness measures being representative of a likelihood that the reward to be presented to the customer would be accepted when offered in response to selection by the customer of the at least one item, and computed based on p=s/N, where p represents the likelihood of the reward being accepted when offered in response to the selection by the customer of the at least one item, s represents a number of successful promotions of the reward when offered in response to the selection by the customer of the at least one item, and N is the number of times the reward has been presented over the period of times to one or more customers in response to a selection of the at least one item by the one or more customers.

In some variations, a system is disclosed that includes one or more processor-based devices, and one or more memory storage devices to store instructions. The instructions, when executed on the one or more processor-based devices, cause operations that include receiving information about at least one transaction, including information about at least one first item selected by a customer in the at least one transaction, and determining data relating to a reward provided to the customer in response to achieving a chance-based outcome for an activity performable by the customer, the data relating to the reward determined, at least in part, based on the received information.

Embodiments of the system may include at least some of the features described in the present disclosure, including at least some of the features described above in relation to the method.

In some variation, a non-transitory computer readable media programmed with a set of instructions executable on a processor is disclosed. The instructions, when executed, cause operations that include receiving information about at least one transaction, including information about at least one first item selected by a customer in the at least one transaction, and determining data relating to a reward provided to the customer in response to achieving a chance-based outcome for an activity performable by the customer, the data relating to the reward determined, at least in part, based on the received information.

Embodiments of the computer readable media may include at least some of the features described in the present disclosure, including at least some of the features described above in relation to the method and the system.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of or “one or more of indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an example system configured to determine and present to customers activities with chance-based outcomes, and rewards therefor.

FIG. 2 is a flowchart of an example procedure to determine and present activities with chance-based outcomes, and rewards therefor.

FIG. 3 is a schematic diagram of a generic computing system.

FIG. 4 is a screenshot of an example activity with a chance-based outcome.

Like reference symbols in the various drawings indicate like elements.

### DETAILED DESCRIPTION

Disclosed herein are methods, systems, apparatus, devices, computer program products, and other implementations, including a method that includes receiving, at one or more processor-based devices, information about at least one transaction, including information about at least one first item selected by a customer in the at least one transaction, and determining, at the one or more processor-based devices, data relating to a reward provided to the customer in response to achieving a chance-based outcome for an activity performable by the customer, the data relating to the reward determined, at least in part, based on the received information. In some embodiments, the at least one transaction may include one or more of, for example, a purchase transaction, and/or a marketing review transaction (e.g., a transaction in which a customer receives and reviews marketing information regarding one or more goods and services). The activity with the chance-based outcome may include one or more of, for example, participating in a chance-based lottery, participating in a scratch card game (e.g., revealing concealed areas of a printed or electronic scratch card to determine if the customer has won a reward).

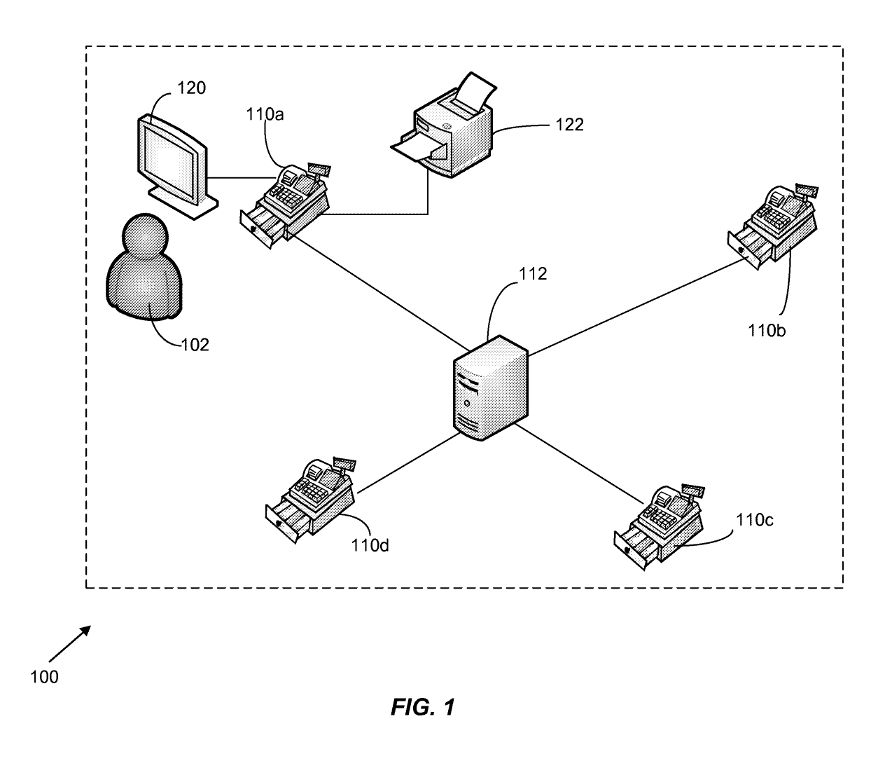

Thus, with reference to FIG. 1, a schematic diagram of a system 100 configured to determine and present activities with chance-based outcomes (e.g., chance-based games, such as raffles, lotteries, etc.), and also determine and present rewards for successful outcomes of those activities, is shown. The system 100 includes one or more point-of-sale stations (e.g., cash registers) 110a-d, at which a customer may complete, for example, purchase transactions. Additional examples of point-of-sale (POS) stations are described in U.S. patent application Ser. No. 11/314,713, entitled “SYSTEMS AND METHODS FOR AUTOMATIC CONTROL OF MARKETING ACTIONS”, and U.S. patent application Ser. No. 11/611,481, entitled “EXPOSURE-BASED SCHEDULING,” the contents of both of which are hereby incorporated by reference in their entireties.

The system 100 may also include, in some embodiments, a central server 112 in communication with the other stations/devices/nodes constituting the system 100, and may be configured to receive data from any of the stations/devices/nodes of the system to centrally process data. For example, the central server 112 may be configured to receive data, such as transaction data, from the various POS stations, or other devices/nodes, with which it is communicating, and determine, at least in part based on the received data, activities that are presentable to, and performable by, customers with respect to whom the data from the POS stations/devices/nodes was received. In some variations, processing of the data collected at a station, such as any of the stations 110a-d, may be performed at the local station at which the data was collected, or alternatively, one or more of the stations may perform data processing for the data collected at the various stations 110a-d. The customers (e.g., a user 102 depicted in FIG. 1) may be customers consummating purchase transactions and/or prospective customers who are interacting with POS devices, e.g., obtaining information about various goods and services and otherwise reviewing marketing data available at the stations with which the customers may be interacting. In some embodiments, the activities that are generated and/or presented to various customers at the stations/nodes of the system 100 may include, for example, presenting lottery tickets or scratch cards (either on an interactive video display or on a printable medium such as paper) which provide chance (probability)-based outcomes. The outcomes can be associated with a reward(s), such that a favorable/successful chance-based outcome is achieved when, for example, at the conclusion of the activity, the customer's lottery ticket or scratch card is one that won the customer the associated reward.

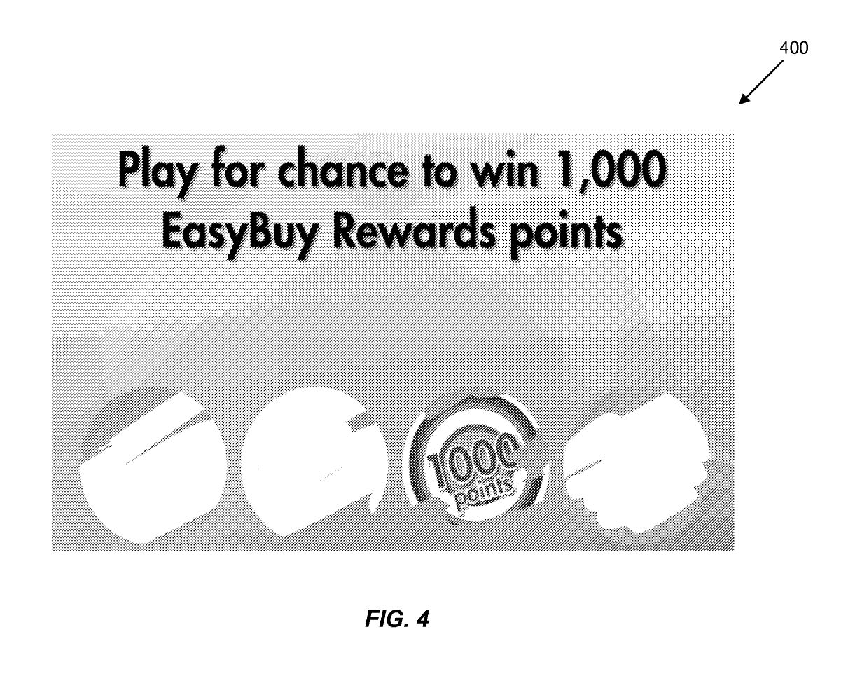

As noted, the customer-performable activities may be presented on an interactive display, or on some printable medium (such as paper). In the example of FIG. 1, the cash register 110a, next to which the customer/user 102 may be standing, is illustrated as being connected to a display/monitor 120 and/or a printer 122. For ease of illustration, only one cash register is illustrated as being coupled to such interface systems as the display 120 Attorney and/or the printer 122, although any one of the stations/nodes constituting the system 100 may be coupled to same or different output systems. Thus, a scratch card may be presented on a display screen (which may be an interactive touchscreen), and the user may then interactively perform the scratch card activity by “scratching” areas on the screen displaying icons corresponding to concealed areas to thus gradually reveal another image or icon under the icons the user scratched. For example, FIG. 4 is a screenshot 400 of a scratch-card type activity that is presented on a display device (which may be a device such as the display device 120 of FIG. 1). A user may be prompted to scratch the concealed areas on the screen (for example, by rubbing the area of a touch screen on which a scratch icon is presented) to gradually reveal the icons concealed by the scratch icons. In the example of FIG. 4, a user is deemed to have won a reward of 1000 redeemable points (referred to as “EasyBuy Rewards Points”) if, after the user completes the scratching activity, at least one of the concealed icons is revealed to be a “1000 Points” icon. In circumstances where the reward is a specified amount of redeemable points, the user can subsequently apply the points to redeem an item associated with at least that value of points, or, alternatively, to reduce the price of an item by an amount corresponding to the specified number of points (e.g., reduce the price of an item by $5 if the user had won 1000 EasyBuy Rewards Points). In some embodiments, the concealed areas of the scratch card (be it an electronic or an actual physical scratch card) may include other types of rewards (e.g., specified discounts, specified items, etc.)

In some embodiments, a user is deemed to have won if the icons/images revealed underneath the scratched icons display a certain threshold number of identical items (e.g., a beverage bottle, a burger, etc., in situations where the scratch card is offered in a food outlet). For example, if the scratch card displays three identical items (e.g., three beverage bottles), the user is determined to have won, and may receive a reward associated with the scratch card (e.g., a discount on a beverage bottle, a free beverage bottle, redeemable points that can be applied to purchase an item at a reduced price, or some other reward). In some implementations, a customer whose scratch card reveals the required threshold number of identical icons of an item will be entitled to a reward only if the customer has already purchased an item such as the item corresponding to the identical icons on the scratch card. For example, when the scratch card reveals three identical beverage bottle icons, a customer that has purchased such an item (e.g., a food item) may then be entitled to receive a beverage at a discount or even receive it for free.

In some embodiments, a favorable/winning outcome is deemed to have occurred if the number of identical items is less than the threshold number, but one of the items already purchased by the customer is a similar item (or an identical item) to that displayed or printed on the scratch card. For example, if the scratch card includes two beverage bottles, and the customer has purchased a beverage (bottled or otherwise), that purchased item may double-up as a scratched item, in which case the customer will be deemed to have had a favorable outcome because it had two identical items icons on his/her scratch card and an actual purchased item related to the scratch card item, for a total of three items (which may then equal the threshold number required for a favorable outcome). When the activity is completed with a favorable/winning outcome occurring, the reward (e.g., an actual free item, a discount, redeemable points) may be provided as a barcode sent to the cash register so that the cash register can apply that barcode to provide the customer with the reward.

In some embodiments, the reward(s) associated with favorable/successful chance-based outcomes of the activities (i.e., when the customer has won or otherwise achieved a successful result) may be determined based on data obtained from the station where the customer is situated and transacting. Such data may include information about a transaction that has been completed (or will be completed) by the customer, data pertaining to information sought by the user while using an interactive station (e.g., seeking information about a particular product or service) information pertaining to the customer, etc.

For example, in some implementations, data from a station, including transaction data (e.g., what items were purchased or are about to be purchased) may be used to determine a reward (e.g., one or more items) in a chance-based activity. Additionally, in some embodiments, the data provided from the station to enable the determination of the reward may include customer information, including general customer characteristics (gender, age, etc.), and more specific customer information collected through the station. In such embodiments, the reward determined may be catered to the customer based, at least in part, on the customer information collected and/or provided. For example, the reward to be presented to a teen-aged male customer, who purchased a particular item, for successfully completing a chance-based activity may be different than the reward provided to an adult female customer who purchased the same particular item. Other customer-related data that may be used in determination of the reward to present to the customer may include the customer's current location, current time, content of the customer's electronic basket (e.g., what items the customer is interested in purchasing), as well as various environmental parameters. In some embodiments, the data collected from the station (e.g., transactional data, customer data, etc.) may also be used, at least in part, to determine what type of chance-based activity to present to the customer (e.g., present a trivia question with along with several possible answers, or present a “scratch-card” activity).

In some embodiments, determination of the reward and/or the chance-based activity to present to the customer may be performed by, for example, randomly selecting a reward and/or activity, applying pre-determined rules or formulation to the input data to determine a corresponding reward and/or activity, or identifying one or more possible candidate rewards (and/or activities) from a database listing multiple combinations of various possible input data (such as items purchased, marketing information sought by the customer, customer data, etc.) with associated rewards/chance-based activities and selecting one or more such combinations associated with a reward (and/or activity). Once a reward and/or a chance-based activity are determined, data representative of the determined reward and/or activity is communicated to an output device (e.g., the display 120 and/or the printer 122 of FIG. 1) coupled to the station at which the customer is located. Such data may include, for example, data required to generate and perform the determined chance-based outcome activity at the output device coupled to the station, and/or particulars of the reward to be provided for successfully completing the activity (e.g., a description of the one or more items constituting the reward, visuals of the items, applicable discounts or specials to be offered as part of the reward, etc.)

As noted, in some embodiments, the reward and/or chance-based activity may be identified from a set of combinations that includes records, or entries, of combinations of input data (e.g., items that were initially chosen by a customer, the customer's particulars) and corresponding rewards and/or chance-based activities, e.g., tangible items, services, a general monetary discount or offer, a coupon, redeemable points that can be applied to reduce a purchase price, etc. Each combination (which may be stored in a central repository, not shown) may be associated with an effectiveness measure that represents the probability that a customer will participate in the chance-based activity and/or use (accept or exercise) the reward if the customer successfully completed the activity. In some embodiments, the combination may also be associated with other data, such as a confidence interval representative of the uncertainly associated with effectiveness measures. Further details regarding implementations of procedures that could be used to determine a reward and/or an activity to present to a customer are described in U.S. application Ser. No. 12/697,867 (issued as U.S. Pat. No. 8,321,276), entitled “PROCESSING OF COMMERCE-BASED ACTIVITIES”, and filed Feb. 1, 2010, the content of which is hereby incorporated by reference in its entirety.

Thus, input data, including information identifying purchased or about-to-be-purchased, items, marketing information sought by the customer about goods and services the customer is interested in, customer-specific information, etc., is used to access a repository of combinations to determine a sub-group with those combinations that match the input data (or at least some part of the input data). In some embodiments, the combination associated with the highest effective measure from the combinations in the determined sub-group is selected, and information based on that combination, including the reward (be it specific items, a general discount, redeemable points, or some other offer) and/or a selected activity are sent to the output device of the station where the customer is situated. In some variations, several combinations may be selected (e.g., 3-5 combinations with the highest respective effectiveness measures), and a scheme incorporating a randomness element may be used to select one of those combinations so that more than one combination (corresponding to rewards and/or chance-based activities) may have an opportunity to be presented to customers.

In embodiments in which combinations of input data and reward/chance-based activities are identified, each combination may be associated with an effectiveness measure, representative of the likelihood, p, that a customer achieving a favorable chance-based outcome of the activity associated with the reward would then accept the reward and make use of it (e.g., purchase a tangible item forming part of the reward at some specified discount). As noted, each combination may also be associated with a confidence interval representative of the uncertainly associated with the effectiveness measure.

Generally, the effectiveness measure and confidence interval associated with a particular combination may be computed, in some embodiments, based on the expression:

p=s/N,

where p is the likelihood that a reward presented and/or won by the customer would be accepted/exercised by the customer (when the reward is offered in response to selection, s represents a success score (the number of times a particular reward presented to customers was accepted) and N is the number of times a particular reward and/or chance-based activity has been presented to a customer. The values p, s and N may be computed based on certain factors that are taken into account (e.g., s may be computed based on certain rules that define under what circumstances an outcome is to be deemed a success, and s may then be reduced by a success factor). The confidence interval, CI, may be computed according to the expression:

CI=z·\sqrt{p·(1−p)/n}

where z represents the number of standard deviations to achieve a required significance (under the assumption of normal distribution). The z factor represents the probability that an actual value will be within the CI. The higher the z factor, the higher that probability is. The required significance, under those circumstances, is computed as (1−z), i.e., the probability it is outside the CI. So if z=1, there is a 69% certainty that the value is within CI. A value of z=1 may be used because the purpose of the confidence interval is to be a comparative measure for different estimate values, thus multiplying it by any constant is generally not required. It is to be noted that z=1 corresponds to statistical significance of about 31%, z=2 corresponds to 5%, and z=3 corresponds to 1%.

To compute the updated effectiveness measure and confidence interval for a particular reward and/or chance-based activity, an adjusted value of N is determined using the relationship:

N_{old}=p_{old}*(1−p_{old})/confidence_{old}².

The updated effectiveness measure may thus be computed according to:

p_{updated}=(p_{old}*N_{old}+p_{measured}*Nₚ)/(N_{old}+Nₚ),

where p_{measured} corresponds to the effectiveness measure computed for the current interval alone (i.e., without factoring in the old effectiveness measure and/or the old confidence interval). Under circumstances where the particular reward and/or an associated activity was not presented in any promotion in the most recent interval, the updated effectiveness measure is simply computed to be p_{old}.

The updated value for the confidence interval may be computed according to the expression:

$${CI}_{updated} = \sqrt{\frac{p \cdot ( 1 - p )}{{N}_{old} + {N}_{p}}}$$

where Nₚ is the number of times in which the particular reward and/or activity, associated with particular input data, has been offered in the current period (i.e., since the last time that the effectiveness measure and confidence interval for that particular reward and/or activity have been computed).

It should be noted that the initial values for the effectiveness measures and confidence intervals for any reward and/or chance-based activity, presented in response to input data (e.g., items purchased by a customer, particulars of the customer, etc.) may be set, for example, to an effectiveness measure of 0 with a confidence interval of 1. Other initial values may be used.

To illustrate the procedure to update selection parameters (e.g., effectiveness measure, confidence interval, etc.) for a particular reward (e.g., a discount on some particular item or service, a free item, redeemable points, etc.) and/or chance-based activity, consider an example in which a particular reward A is associated with an effectiveness measure of, for example, 2.5% that was previously computed based on a success score of 5 (e.g., five successful promotions) resulting from 200 promotions involving the reward A. The current confidence interval for the reward A is computed CI_{A}=\sqrt{0.025*(1−0.025)/200}=as 0.011. These parameters are subsequently used in the selection process to determine a reward to present to a customer in response to customer-related input data.

When these parameters are to be updated (e.g., at the end of some pre-determined period), the sum of successful offers resulting from N number of promotions following the most recent update (which resulted in the current effectiveness measure 0.025 and a confidence interval of 0.011) will be used to compute the updated parameters. Suppose that in the above example, over the subsequent pre-determined period (e.g., a week) the reward A was promoted 250 times, and those reward promotions resulted in 10 successful promotion acceptances. Thus, during the current period, Nₚ is 250 and the new effectiveness measure, p_{measured} is 10/250=0.04

Suppose also that the old confidence interval associated with the reward A was modified daily to reflect the increasing uncertainty of the validity of the aging parameters, and that by week's end the old confidence interval for the reward A was modified from its initial 0.011 value to 0.012 (in some embodiments, this modification may occur at set intervals based on some pre-determined function). Accordingly, to update the old parameter values of the effectiveness measure and the confidence interval, an adjusted value N that corresponds to the effectiveness measure of 0.025 and the modified confidence interval of 0.012 is computed according to:

N=p(1−p)CI²,

where p is the effectiveness measure representative of the likelihood that a customer would accept a promotion of the reward A in response to the input data related to that customer (e.g., the customer's purchase of certain goods, particulars relating to the customer, etc.) Plugging in the values of p=0.025 and CI=0.012, the corresponding adjusted value of N is computed to be approximately 169 samples.

With that computed adjusted value of N corresponding to the periodically modified old confidence interval value, the updated effectiveness measure and updated confidence interval are computed according to the Equations:

$${p}_{updated} = ( {p}_{old} * {N}_{old} + {p}_{measured} * {N}_{p} ) / ( {N}_{old} + {N}_{p} )$$

$$and {CI}_{updated} = \sqrt{\frac{p \cdot ( 1 - p )}{{N}_{old} + {N}_{p}}}$$

to yield the values of p_{updated}=0.034 and CI_{updated}=sqrt(0.034*(1−0.034)/(169=250)=0.0088.

In the above computation, factors, such as the randomness success factor (RSF), were not taken into account. However, in some implementation, the RSF, as well as other factors, may be taken into account to compute the selection parameters such as the effectiveness measure and/or the confidence interval.

In some embodiments, determination of a reward and/or activity presentable to the customer may be performed using a machine learning system. In some implementations, a machine learning system may be configured to iteratively analyze training input data and the input data's corresponding output, and derive functions or models that cause subsequently received input data (e.g., items purchased or considered by a customer, customer-specific info, etc.) to produce outputs consistent with the machine's learned behavior. In some embodiments, the learning machine system may be implemented based on a neural network system. A neural network includes interconnected processing elements (effectively the systems neurons). The connections between processing elements in the neural network have weights that cause output from one processing element to be weighed before being provided as input to the next interconnected processing elements. The weight values between connections can be varied, thereby enabling the neural network to adapt (or learn) in response to training data it receives. In some embodiments, the learning machine may be implemented as a support vector machine configured to generate, for example, classification functions or general regression function. In some embodiments, the learning machine may be implemented using decision trees techniques, regression techniques to derive best-fit curves, and/or other types of machine learning techniques.

Determination of a probability to be assigned for a successful/favorable chance-based outcome of the activity presentable to the customer may be based, for example, on such factors as the items selected by the customer, personal information of the customer (to the extent such information is available), the actual reward that is to be offered to the customer, existing inventory and available marketing budget/resources of the entity implementing the reward-based activities, the frequency at which certain rewards have been offered by the implementing entity over some pre-set period of time, etc. For example, where the particular items that have been selected (or considered) by the customer are used as a basis for determining the reward to be offered to the customer, historical data indicating that customers who selected those particular items are likely to purchase another item may result in an offering of a particular reward (which may also have been determined based, at least in part, on the particular item(s) selected by the customer, as described above) with a high degree of likelihood (e.g., 60%, 70%, 90%, or any other appropriate probability) of a successful outcome of the particular activity presented to the customer.

As noted, personal data of the customer may also be used as a basis for determining the probability associated with the chance-based activity outcome. For example, frequency of transactions by the customer at the implementing entity (e.g., whether the customer regularly purchases items at the implementing entity) may, for example, be used to determine the probability assigned to the chance-based activity outcome (e.g., a frequent customer may be presented with an activity with a higher than normal probability for the chance-based outcome to occur). The actual reward determined to be offered may also be used to determine the probability of the chance-based activity outcomes. For example, more valuable rewards may cause a lower probability to be assigned for a successful chance-based outcome of the activity presentable to the customer.

In some implementations, determination of the reward to be offered and the probability assigned to the chance-based outcome may be performed concomitantly/jointly (e.g., a single procedure to determine the reward and assigned probability based on one or more factors), or may be determined independently of each other. In some embodiments, data about what the customer has already purchased may result in determining a reward matching, or related to, one or more of the customer's purchased items, and may also result in determining a high probability for winning that reward. For example, data indicating that the user has purchased a beverage bottle may result in determining a beverage bottle reward (e.g., a discount to be applied to the bottle that the customer wishes to purchase) to be associated with an activity presentable to the customer (e.g., scratch card activity), and may also result in determining a relatively high probability for winning that reward (e.g., 70-90%), while generally still maintaining some level of randomness in relation to that chance-based outcome of the activity.

As noted, in some embodiments, determination of which activity to present to the customer may also be determined based on one or more factors, including the customer-related input data that is received.

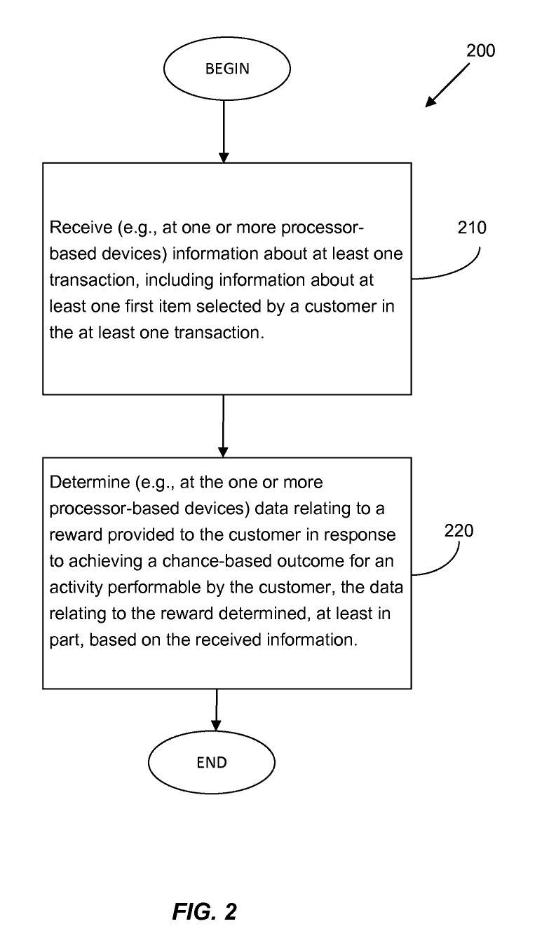

With reference now to FIG. 2, a flowchart of an example procedure 200 to determine rewards and activities with chance-based outcomes to be presented to a customer is shown. The procedure 200 includes receiving 210 (e.g., at one or more processor-based computing devices, such as the server 112 depicted in FIG. 1) information about at least one transaction, including information about at least one first item selected by a customer in the at least one transaction. In some embodiments, the information received about the at least one transaction may also include information about the customer, such as broad characteristics of the customer (e.g., age, gender, etc.), as well as more personal information (e.g., identity, address, history of transactions by the user, etc.)

Data relating to a reward that is to be provided to the customer when the customer achieves a chance-based outcome for an activity performable by the customer is determined 220 based, at least in part, on the received information. Such data relating to the reward may include what reward to offer to the customer, etc. In some embodiments, the procedure 200 may further include determining which chance-based activity to present to the customer (e.g., a lottery-based activity, a scratch card based activity, etc.), and determining a probability value for successful completion of the chance-based activity. In some embodiments, determination of the particular chance-based activity to present to the customer, and/or determination of the probability for that activity, may be based, at least in part, on the information related to the at least one transaction.

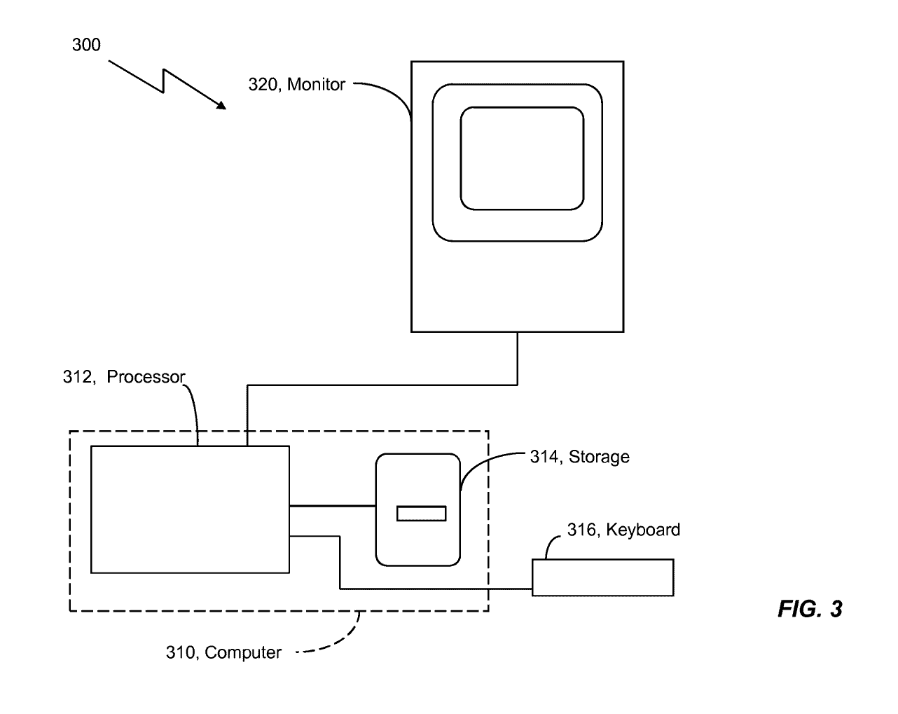

Performing the various operations described herein may be facilitated by a processor-based computing system. Particularly, at least some of the various systems/devices described herein may be implemented using one or more processing-based devices. Thus, with reference to FIG. 3, a schematic diagram of a generic computing system 300 is shown. The computing system 300 includes a processor-based device 310 such as a personal computer, a specialized computing device, and so forth, that typically includes a central processor unit 312. In addition to the CPU 312, the system includes main memory, cache memory and bus interface circuits (not shown). The processor-based device 310 may include a mass storage element 314, such as a hard drive or flash drive associated with the computer system. The computing system 300 may further include a keyboard, or keypad, or some other user input interface 316, and a monitor 320, e.g., a CRT (cathode ray tube) or LCD (liquid crystal display) monitor, that may be placed where a user can access them.

The processor-based device 310 is configured to facilitate, for example, the implementation of operations to receive customer-related input information (e.g., information about transactions, information about the customer, etc.) and to determine data relating to a reward and/or a chance-based activity based, at least in part, on the received information, as well as perform other general computer-based operations. The storage device 314 may thus include a computer program product that when executed on the processor-based device 310 causes the processor-based device to perform operations to facilitate the implementation of the above-described procedures. The processor-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, etc., may be used in the implementation of the system 300. Other modules that may be included with the processor-based device 310 are speakers, a sound card, a pointing device, e.g., a mouse or a trackball, by which the user can provide input to the computing system 300. The processor-based device 310 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed:

1. A system comprising:
a plurality of point of sale (POS) devices each comprising:
a processor;
an input device configured to receive user input indicative of selected items or services; and
a memory configured to store computer program code configured to, with the processor, cause the POS device to:
receive an indication of at least one selected item or service from the input device; and
automatically generate transaction data indicative of a transaction including the at least one selected item or service;
a reward server comprising:
a server processor; and
a server memory configured to store server computer program code configured to, with the server processor, cause the reward server to:
receive, in real time, transaction data from the plurality of POS devices, wherein the transaction data is indicative of at least one selected item or service associated with a transaction at each of the plurality of POS devices;
determine reward data based, at least in part, on the at least one selected item or service, wherein the reward data is to be provided to the customer in response to achieving a chance-based outcome for an activity performable by the customer; and
cause the activity to be presented to the customer, in real time, wherein presenting the activity comprises displaying the activity on an interactive display device or printing at least a portion of the activity on a printer, wherein the interactive display device or the printer are in communication with the reward server;
wherein determining the reward data comprises determining the reward to be presented to the customer based on the information about the at least one selected item or service selected by the customer and based on effectiveness measures that are each associated with at least one combination from a set of combinations that each includes the at least one selected item or service and a corresponding reward to be presented to the customer, each of the effectiveness measures being representative of a likelihood that the reward to be presented to the customer would be accepted when offered in response to selection by the customer of the at least one selected item or service, and computed based on p=s/N, where p represents the likelihood of the reward being accepted when offered in response to the selection by the customer of the at least one selected item or service, s represents a number of successful promotions of the reward over a period of time when offered in response to the selection by the customer of the at least one selected item or service, and N is the number of times the reward has been presented over the period of time to one or more customers in response to a selection of the at least one selected item or service by the one or more customers, and wherein determining the data relating to the reward further comprises determining probability for a successful outcome of the activity based, at least in part, on one or more of the determined reward to be presented to the customer, available resources, or the at least one selected item or service selected by the customer.

2. The system of claim 1, wherein the transaction comprises a purchase transaction or a marketing review transaction.

3. The system of claim 1, wherein the server memory and server computer program code are further configured to, with the server processor, cause the reward server to:
determine the activity, wherein the activity includes a chance-based outcome; and
determine a probability value for the chance-based outcome of the activity based, at least in part, on the transaction data.

4. The system of claim 3, wherein the activity is determined based on the transaction data.

5. The system of claim 1, wherein the transaction data further comprises information about the customer.

6. The system of claim 1, wherein the activity comprises participating in a chance-based lottery or revealing concealed areas of a scratch card.

7. The system of claim 1, wherein the activity is performable by the customer on a printable medium.

8. The system of claim 1, wherein the activity is performable by the costumer on the interactive display device.

9. The system of claim 8, wherein the activity comprises a virtual scratch card.

10. The system of claim 1, wherein the reward comprises a second item offered at a discount.

11. A reward server comprising:
a server processor; and
a server memory configured to store server computer program code configured to, with the server processor, cause the reward server to:
receive, in real time, transaction data from a plurality of POS devices, wherein the transaction data is indicative of at least one selected item or service associated with a transaction at each of the plurality of POS devices, wherein the at least one selected item or service is based on user input received from an input device associated with a respective POS device;
determine reward data based, at least in part, on the at least one selected item or service, wherein the reward data is to be provided to the customer in response to achieving a chance-based outcome for an activity performable by the customer; and
cause the activity to be presented to the customer, in real time, wherein presenting the activity comprises displaying the activity on an interactive display device or printing at least a portion of the activity on a printer, wherein the interactive display device or the printer are in communication with the central server;
wherein determining the reward data comprises determining the reward to be presented to the customer based on the information about the at least one selected item or service selected by the customer and based on effectiveness measures that are each associated with at least one combination from a set of combinations that each includes the at least one selected item or service and a corresponding reward to be presented to the customer, each of the effectiveness measures being representative of a likelihood that the reward to be presented to the customer would be accepted when offered in response to selection by the customer of the at least one selected item or service, and computed based on p=s/N, where p represents the likelihood of the reward being accepted when offered in response to the selection by the customer of the at least one selected item or service, s represents a number of successful promotions of the reward over a period of time when offered in response to the selection by the customer of the at least one selected item or service, and N is the number of times the reward has been presented over the period of time to one or more customers in response to a selection of the at least one selected item or service by the one or more customers, and wherein determining the data relating to the reward further comprises determining probability for a successful outcome of the activity based, at least in part, on one or more of the determined reward to be presented to the customer, available resources, or the at least one selected item or service selected by the customer.

12. The reward server of claim 11, wherein the transaction comprises a purchase transaction or a marketing review transaction.

13. The reward server of claim 11, wherein the server memory and server computer program code are further configured to, with the server processor, cause the reward server to:
determine the activity, wherein the activity includes a chance-based outcome; and
determine a probability value for the chance-based outcome of the activity based, at least in part, on the transaction data.

14. The reward server of claim 13, wherein the activity is determined based on the transaction data.

15. The reward server of claim 11, wherein the transaction data further comprises information about the customer.

16. The reward server of claim 11, wherein the activity comprises participating in a chance-based lottery or revealing concealed areas of a scratch card.

17. The reward server of claim 1, wherein the activity is performable by the customer on a printable medium.

18. The reward server of claim 11, wherein the activity is performable by the costumer on the interactive display device.

19. The reward server of claim 18, wherein the activity comprises a virtual scratch card.

20. The reward server of claim 11, wherein the reward comprises a second item offered at a discount.
